(19) United States
(12) Patent Application Publication
(10) Pub. No.: US 2015/0161123 A1
(43) Pub. Date: Jun. 11, 2015

(54) TECHNIQUES TO DIAGNOSE LIVE SERVICES

(71) Applicant: Microsoft Corporation, Redmond, WA (US)

(72) Inventors: DAVID STERLING, Apex, NC (US); ABHISHEK KUMAR CHATURVEDI, Redmond, WA (US)

(73) Assignee: Microsoft Corporation, Redmond, WA (US)

(21) Appl. No.: 14/101,227

(22) Filed: Dec. 9, 2013

(51) Int. Cl. G06F 17/30; G06F 17/27

(52) U.S. Cl. CPC G06F 17/3048; G06F 17/272

(57) ABSTRACT

An apparatus to diagnose a live service includes a processor circuit; and a request handler component executing on the processor circuit to service a process request that generates process data. The request handler component may comprise a process object to receive a query comprising: a property to fetch and a condition. The process object may further comprise a condition evaluator to evaluate the condition against an executing process request; and a data requestor to fetch the property from the process data when the condition is true, and to write the property to a log file.

### BACKGROUND

Large data centers and service provider server “farms” may service hundreds, thousands, or more, of requests for data and services at a time. When errors, inefficiencies, or other problems occur, it may be difficult to determine the conditions surrounding the problem in a way that doesn't disrupt service for all requesting clients. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to diagnose live services. Some embodiments are particularly directed to techniques and apparatuses to diagnose live services using conditional handlers within a service process on a service device. In one embodiment, for example, an apparatus may comprise a processor circuit; and a request handler component executing on the processor circuit to service a process request that generates process data. The request handler component may comprise a process object to receive a query comprising a property name and a condition. The process object may further comprise a condition evaluator to evaluate the condition against an executing process request, and a data requestor to fetch at least one property associated with the property name from the process data when the condition is true, and write the property to a log file. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to diagnose live services.

FIG. 2 illustrates an embodiment of an environment to diagnose live services.

FIG. 3 illustrates an embodiment of a process object.

FIG. 4 illustrates an embodiment of a message flow.

FIG. 5 illustrates a second embodiment of a message flow.

FIG. 6 illustrates an embodiment of a query.

FIG. 7 illustrates an embodiment of a dashboard user interface.

FIG. 8 illustrates a second embodiment of a dashboard user interface.

FIG. 9 illustrates an embodiment of a centralized system.

FIG. 10 illustrates an embodiment of a distributed system.

FIG. 11 illustrates a logic flow for the system of FIG. 1.

FIG. 12 illustrates an embodiment of a computing architecture.

FIG. 13 illustrates an embodiment of a communications architecture.

### DETAILED DESCRIPTION

Various embodiments are directed to techniques to diagnose live services. Administrators of computing service centers face challenges when diagnosing problems. Service centers typically receive many requests for service in short periods of time, and the parameters and context of each service request may vary. Isolating the conditions that surround a single problem without affecting the service to the other clients has not been possible. Conventional solutions may include attaching a debugger to a process, or forcing a condition to observe the results. Some of these conventional solutions may only work, if at all, when performed on premise by an administrator with direct access to the servers.

With the advent of cloud computing services, administrators are often not on premise, and must use remote diagnostics. These conventional remote solutions may include inserting break points into the process having the problem. However, when a break point occurs, service stops for all clients using the process and/or device. Another conventional approach may be to use continuous logging or tracing of the process and data, but this may significantly increase the load on the service system.

With these in mind, embodiments provide a method of retrieving information about a process conditionally, typically based on events. This does not force an administrator to watch continuously for an event, does not collect excessive amounts of irrelevant data, and does not interfere with otherwise normal operation. In various embodiments an administrator can build a query that specifies one or more conditions to watch for, and one or more properties to fetch when the condition occurs. A process can expose information about itself, and a process object of that process can watch for the conditions in the query. When a queried condition occurs, the process object can retrieve the properties and return them to the requestor or write them to a log file for asynchronous viewing. In some embodiments, the process object does not need to know anything about the process other than what information is exposed and how to access the information.

Accordingly, embodiments may provide a non-invasive, event-based data collection technique that does not require, for example, that a debugger be attached to a process or that all process be captured. The ability to define a query dynamically using whatever properties a process exposes provides greater diagnostic flexibility that does not require that a process or the service be re-compiled and re-deployed.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the specified purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

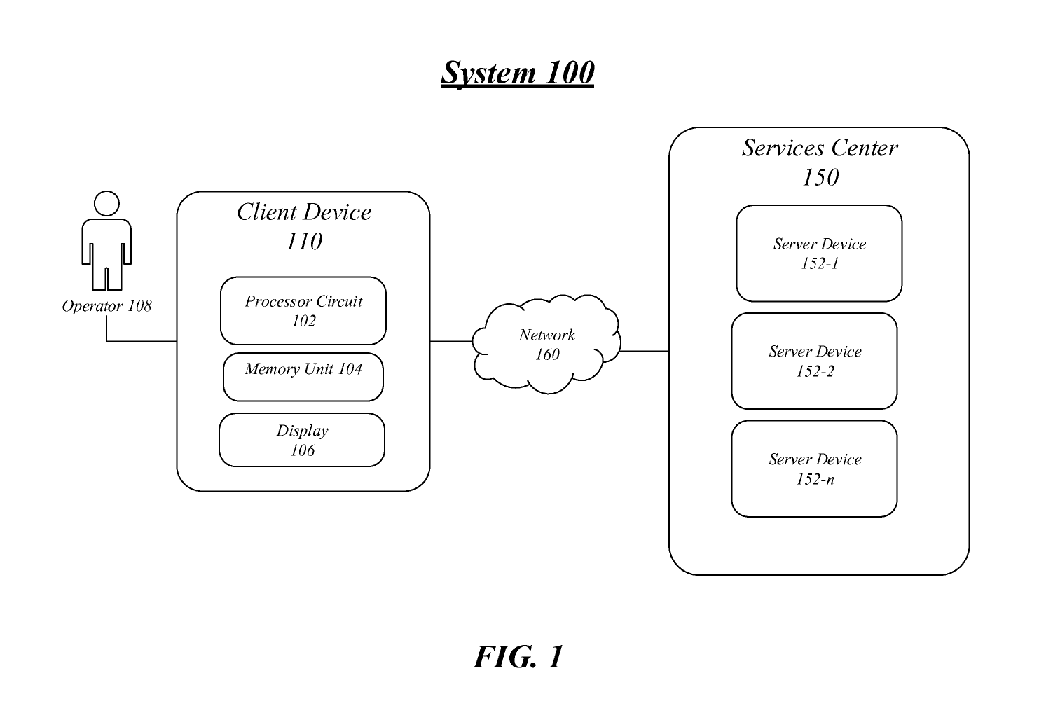

FIG. 1 illustrates a block diagram for a system 100. In one embodiment, the system 100 may comprise a computer-implemented system 100 having various elements, such as a services center 150, and a client device 110 communicatively coupled to the services center 150 via a network 160. Although the system 100 shown in FIG. 1 has a limited number of elements in a certain topology, it may be appreciated that the system 100 may include more or less elements in alternate topologies as desired for a given implementation.

The system 100 may comprise a services center 150. Services center 150 may represent a collection of computing resources that together provide services to client devices. Services center 150 may represent a “farm” such as may be used by a cloud computing service provider. Services center 150 may provide services to multiple client entities, such as different businesses, government organizations, educational institutions, and so forth. Examples of services provided may include, for example and without limitation, electronic mail services, collaboration software services, business software services, and so forth. Services center 150 may receive requests from individual remote devices, for example, to retrieve e-mail for a user, to retrieve a document for editing, to modify a document, to update a business database, and so forth. The embodiments are not limited to these examples.

Services center 150 may include one or more server devices 152-1, 152-2, 152-n, where n represents a positive integer. The server devices 152 may be physically co-located, or may be geographically dispersed. A server device 152 may include any electronic device capable of receiving, processing, and sending information for the system 100. Examples of an electronic device may include, without limitation, an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The system 100 may comprise a client device 110. Client device 110 may be usable by an operator 108, e.g. an administrator or technician, to generate and submit diagnostic queries to services center 150, and to receive and view information retrieved according to the diagnostic queries. Client device 110 may also represent any device used to request services from services center 150. Client device 110 may include any electronic device as described above.

Client device 110 may execute processing operations or logic for the system 100 using a processor circuit 102. Processor circuit 102 may comprise various hardware elements. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth.

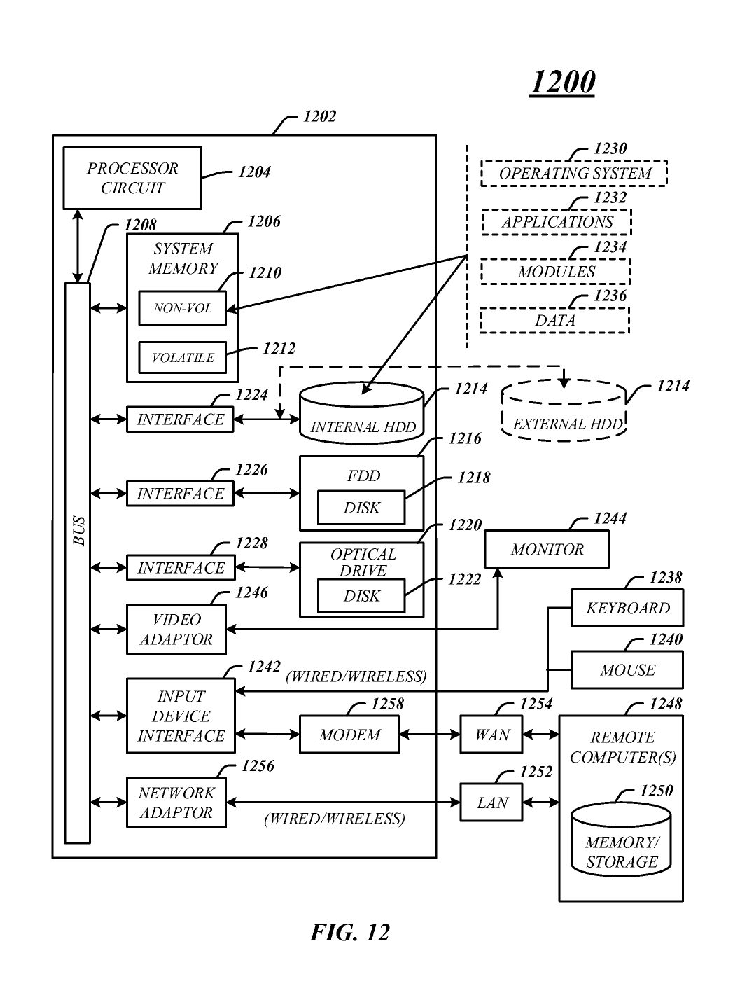

Client device 110 may include one or more memory units 104. A memory unit 104 may include various computer-readable storage devices, volatile and non-volatile, that store data and instructions for retrieval by processor circuit 102. As used herein, a memory unit 104 does not include signals or carrier waves, such as electromagnetic or optical waves. Memory units are described further with respect to FIG. 12.

Client device 110 may include a display 106. Display 106 may be integrated into electronic device 110, or may be separate but communicatively coupled to electronic device 110. Display 106 may include a touch-sensitive surface that can detect a touch gesture or a proximity gesture, which may include contact with, or proximity to, items such as a human fingertip, a stylus, an electronic pen, and so forth. Display 106 may also include conventional computer monitors or integrated laptop computer screens.

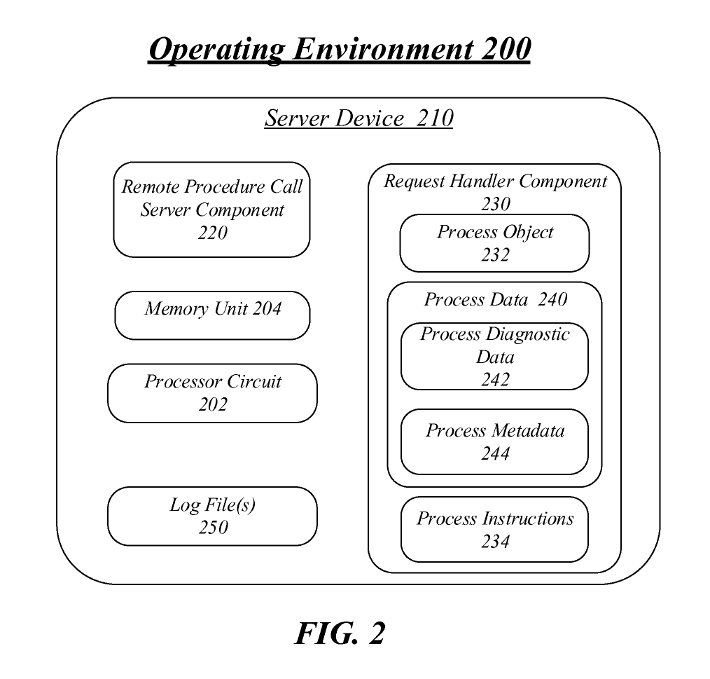

FIG. 2 illustrates an embodiment of an operating environment 200. Operating environment 200 may include a server device 210. Server device 210 may be a representative example of a server device 152. Server device 210 may include various components, such as a remote procedure call (RPC) server component 220 and a request handler component 230. Server device 210 may also include a processor circuit 202 and a memory unit 204, which may be analogous to processor circuit 102 and memory unit 104. More, fewer, or alternate components may be used.

RPC server component 220 may receive remote procedure calls from clients of services center 150 and may pass the remote procedure calls to the relevant processes for servicing. RPC server component 220 may also return data to the clients. RPC server component 220 may receive a registration from a process that exposes the properties of the process for diagnostics. In an embodiment, inter-process communication protocols other than RPC may be used. The RPC server component 220 is therefore not limited to only the RPC protocol.

Server device 210 may include a request handler component 230. Request handler component 230 may represent one or more processes that service a request received by services center 150. Request handler component 230 may receive requests and execute process instructions 234 to serve the requests.

While processing requests, request handler component 230 may generate process data 240. Process data 240 may include, for example and without limitation, process diagnostic data 242 and process metadata 244. Process diagnostic data 242 may be data that is collected when requested but not generated in the course of servicing the request. Process metadata 244 may be data that is generated, read, transformed, fetched or otherwise used during the servicing of a request. Process metadata 244 may be generated regardless of whether the process is being checked for diagnostic purposes. Examples of process metadata may include, without limitation, a command name, a procedure name, an actual caller, an effective caller, an elapsed time, a user name, a server name, variable names, variable values, and so forth.

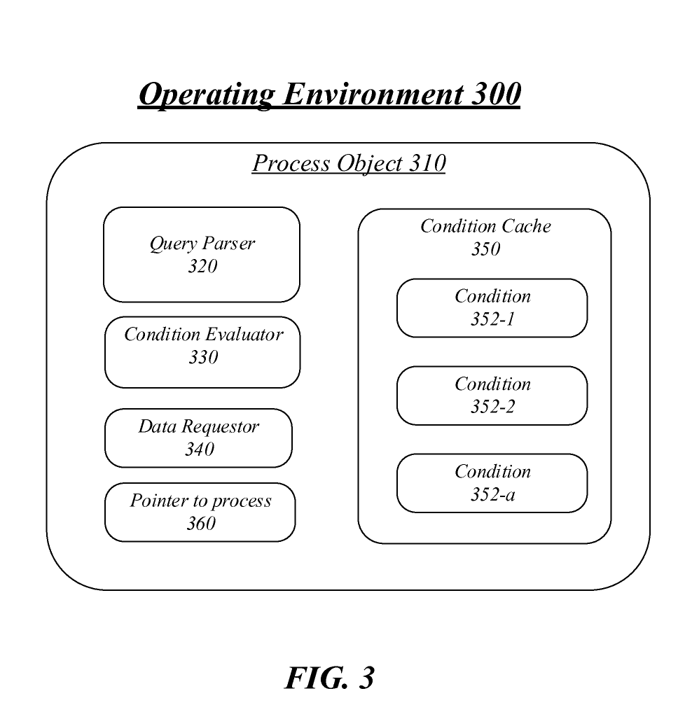

Request handler component 230 may include a process object 232. Process object 232 may be a class object inside of request handler component 230. Process object 232 may receive queries, parse the queries into conditionals for evaluation, evaluate the conditionals against the process, and return information when a conditional evaluates to “true.” Process object 232 is discussed in more detail with respect to FIG. 3.

Request handler component 230 may include process instructions 234 that are executable by processor circuit 202 to perform various operations related to servicing a request for a service. Examples of instructions may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Process object 232 may generate one or more log files 250. A log file 250 may be a text file, an extensible markup language (XML) file, a database, a spreadsheet, or any other stored grouping of process data 240 retrieved from a process in response to a query. Log file 250 may be stored on server device 210, or may be stored remotely thereto while being accessible by a client such as client device 110 and by RPC server component 220.

FIG. 3 illustrates an embodiment of an operating environment 300. Operating environment 300 may include a process object 310. Process object 310 may be a representative example of process object 232. Process object 310 may comprise various functional components, such as a query parser 320, a condition evaluator 330, and a data requestor 340. Process object 310 may also store a pointer 360 to a process, and a conditional cache 350. More, other, or fewer functional components may be used.

Process object 310 may receive a query from a client device. The query may be a string comprising one or more conditions to evaluate against a process and one or properties to fetch when at least one of those conditions evaluates to true. Process object 310 may include a query parser 320 to parse the query into one or more conditionals 352-1, 352-2, 352-a, where a represents a positive integer. Parsing the query may include parsing the conditionals from string form into strong types and then storing the one or more conditionals in a conditional cache 350 for evaluation.

Process object 310 may include a condition evaluator 330 to evaluate a condition against a process request. The request handler component 230 may prompt process object 310 to evaluate any cached conditionals at any time during or after a process is executed by request handler component 230. Condition evaluator 330 can access process data 240 and use it to evaluate the conditionals 352.

Process object 310 may include a data requestor 340 to fetch the one or more properties requested in the query from process data 240 when the condition is true. Data object 310 may include a pointer 360 to the process data. Data requestor 340 may use the pointer 360 to access the process data 240 to fetch the one or more properties. In some embodiments, the fetched properties may be written to a log file 250. Alternatively, or in addition, the fetched properties may be returned to the requesting client as they are retrieved.

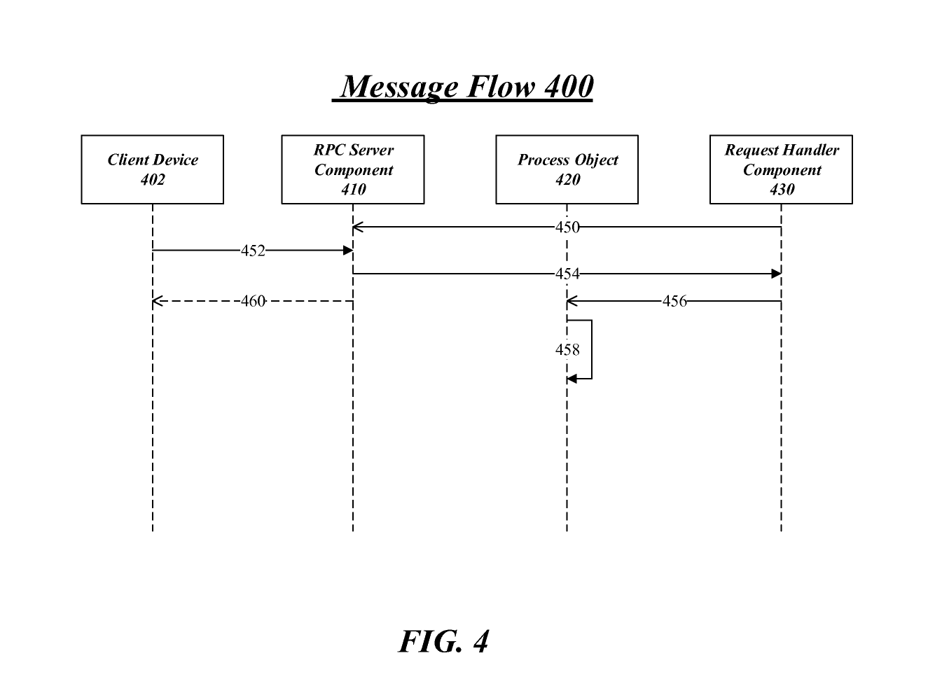

FIG. 4 illustrates an embodiment of a message flow 400. Message flow 400 may represent messages communicated among the components of system 100. In particular, message flow 400 may occur among a client device 402, an RPC server component 410, a process object 420, which may be representative of client device 110, RPC server component 220, process object 232, respectively, and a process 430, which may represent a request handler component 230 and/or a process executed by request handler component 230. In message flow 400, time flows from the top of the diagram toward the bottom. Message flow 400 may represent messages communicated during a process start-up.

Message flow 400 may begin when process 430 starts up, prior to servicing any requests, and sends a message 450 to register with RPC server component 410 as being diagnosable. This registration exposes one or more methods at the RPC server component that provide an entry point for a client device to request that conditions be monitored in process 430 and process data be returned.

Message flow 400 may continue when a client device 402 submits a conditional handler 452 to RPC server component 410 for registration. The conditional handler 452 may include a query having at least one condition to monitor and at least one property or process data item to return when the condition occurs. The conditional handler 452 may also include optional parameters that modify the condition. In various embodiments, the conditional handler 452 may be specific to one server device 210 and/or may specify the process to monitor. In other embodiments, the conditional handler 452 may include parameters that specify the process to monitor and/or the specific server device to monitor.

RPC server component 410 may forward the query from conditional handler 452 to process 430 in message 454. RPC server component 410 may determine which process to forward the query to when conditional handler 452 includes a indication of the desired process to monitor.

Process 430 may pass the query to process object 420 in message 456. Message 456 may be, for example, a procedure or function call. In an embodiment, RPC server component 410 may be able to pass the query to process object 420 directly.

Process object 420 may parse the query into conditionals and register the conditionals within the conditional cache in block 458. When a query comprises a simple property-property value pair to watch for, one conditional may be registered within the conditional cache. When a query comprises a plurality of properties and property values to watch for, a plurality of conditionals may be registered in the conditional cache.

As part of the conditional handler registration, RPC server component 410 may generate and return an identifier for the conditional handler to the client device 402 in message 460. Client device 402 may be able to use the identifier to retrieve any fetched properties later.

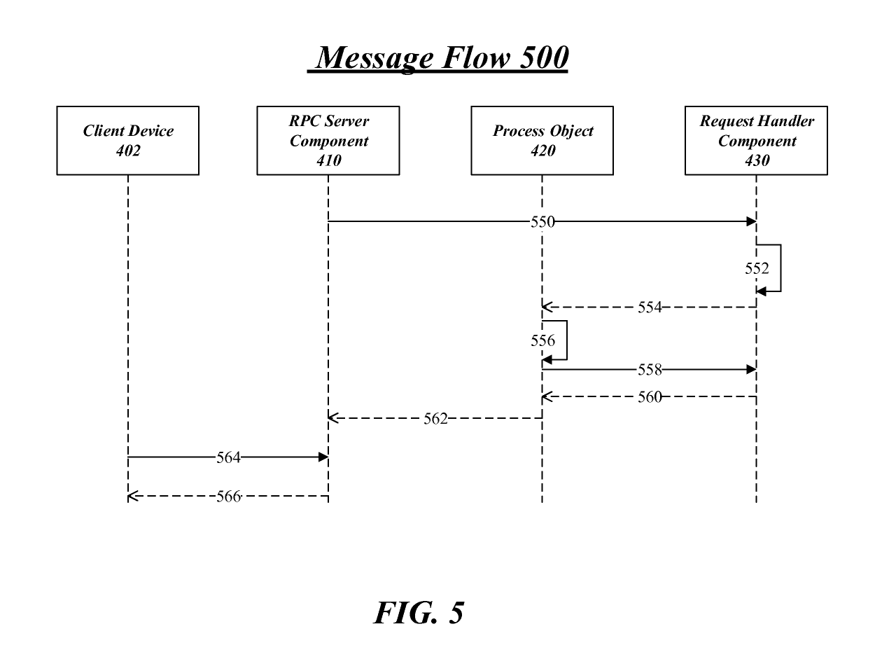

FIG. 5 illustrates specific example of a message flow 500. Message flow 500 may represent messages communicated among the components of system 100 and may continue message flow 400 in that a conditional handler has been received and registered.

Message flow 500 may begin after a process request (not shown) is received at RPC server component 410. The process request may be for any service provided by services center 150, and in particular, for a service provided by the server device 152 that includes RPC server component 410. The process request may come from any client of services center 150, which may be different from client device 402. RPC server component 410 may send the process request to process 430 for servicing in message 550.

Process 430 may service the process request at block 552. At some time during the servicing or after, process object 420 may prompt process object 420 to evaluate the conditionals with message 554.

Process object 420 may evaluate the registered conditionals against the process at block 556. For example, process object 420 may determine which conditionals are true according to the process data for process 430.

When a conditional evaluates to “true,” e.g. when an element of process data matches a condition, process object 420 may request the properties specified in the query from process 430 with message 558. Process object 420 may be able to access the properties directly using pointer 360, or may use a procedure call to request the data. The properties may be returned to process object 420 in message 560.

Process object 420 may write the fetched properties to a log file 250 in message 562. Log file 250 may be provided to RPC server component 410 for writing to the server device, or may be written to the server device directly by process object 420.

At some time later, client device 402 may request the log file in message 564. Client device 402 may use the identifier provided at the time of registering the conditional handler to request the log file. RPC server component 410 may send a link to the log file in message 566. Alternatively, RPC server component 410 may send a copy of the actual log file, may allow access to the log file via in interface, or otherwise allow the contents of the log file to be viewed on client device 402. The embodiments are not limited to these examples.

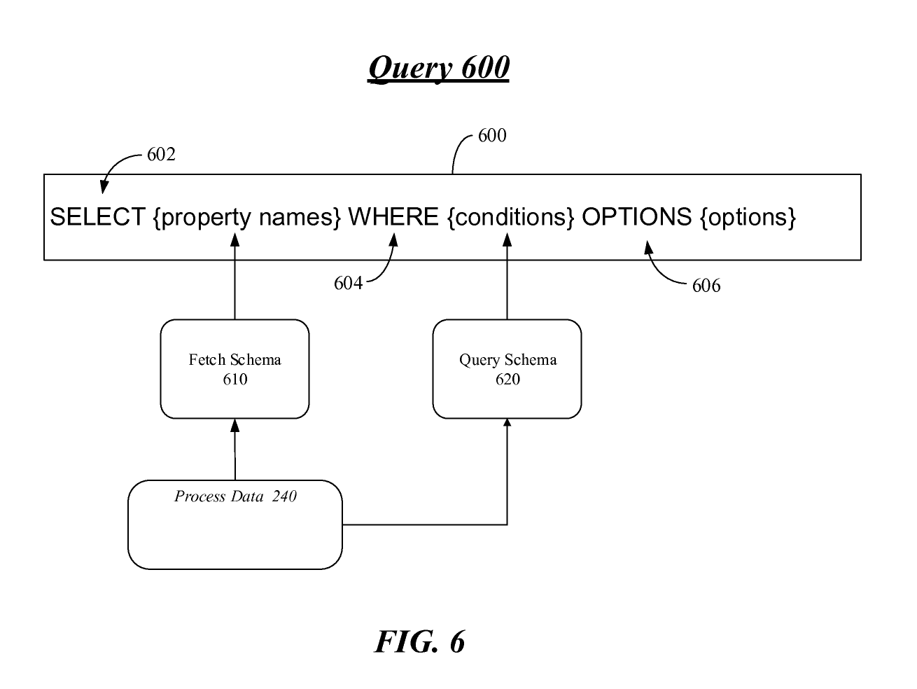

FIG. 6 illustrates an embodiment of a query 600. Query 600 may be a component of a conditional handler sent from a client device 110 to a RPC server component 220. Query 600 may include at least two elements: a select statement 602 and a condition statement 604. Query 600 may optionally include an options statement 606.

Select statement 602 may comprise a command, for example and without limitation “select”, “fetch”, “get”, and so forth, and a set of at least one property to retrieve from a process. The select statement 602 may include property names from a fetch schema 610 that identifies properties from process data 240 that the operator 18 wants to have returned. The property names may be in the form of a text string, but are not necessarily limited to being strings. In some cases, a property name group may be used in replacement of a property name. A property name group may resolve to a set of property names corresponding to properties on the server side.

Condition statement 604 may include a conditional command, for example, and without limitation “where”, “when”, “if” and so forth, and a set of at least one condition to be evaluated against the process. The condition statement 604 may include conditions selected from a query schema 620 that identifies properties from process data 240 that are to be evaluated. The conditions may be in the form of a text string, but are not limited to being strings.

Options statement 606 may, when used, include one or more options that modify the evaluation. For example, the options may specify that the conditions should stop being evaluated after a specified number of true evaluations are achieved, or after an elapsed time. The embodiments are not limited to these examples.

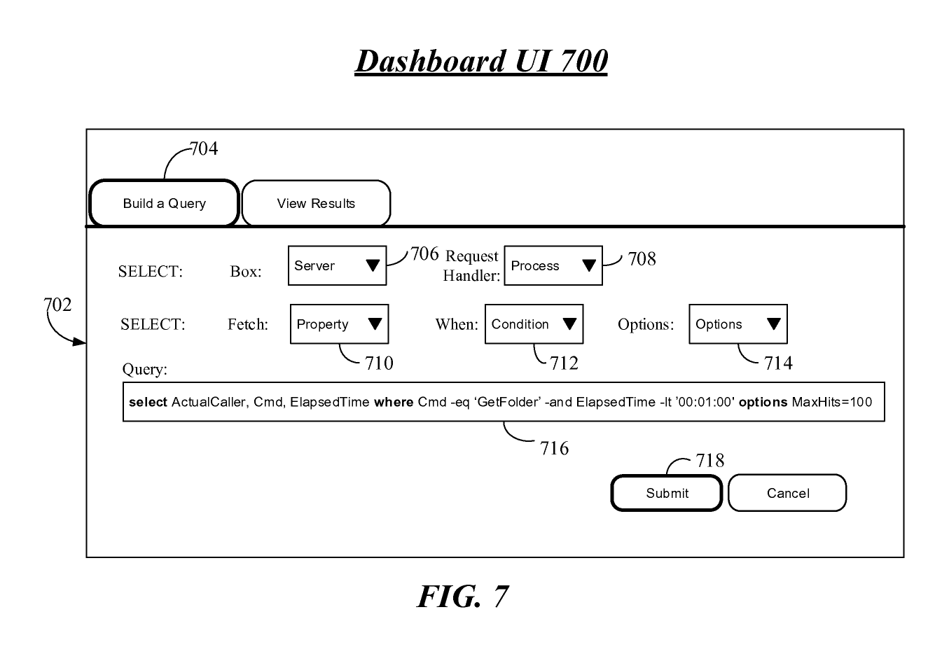

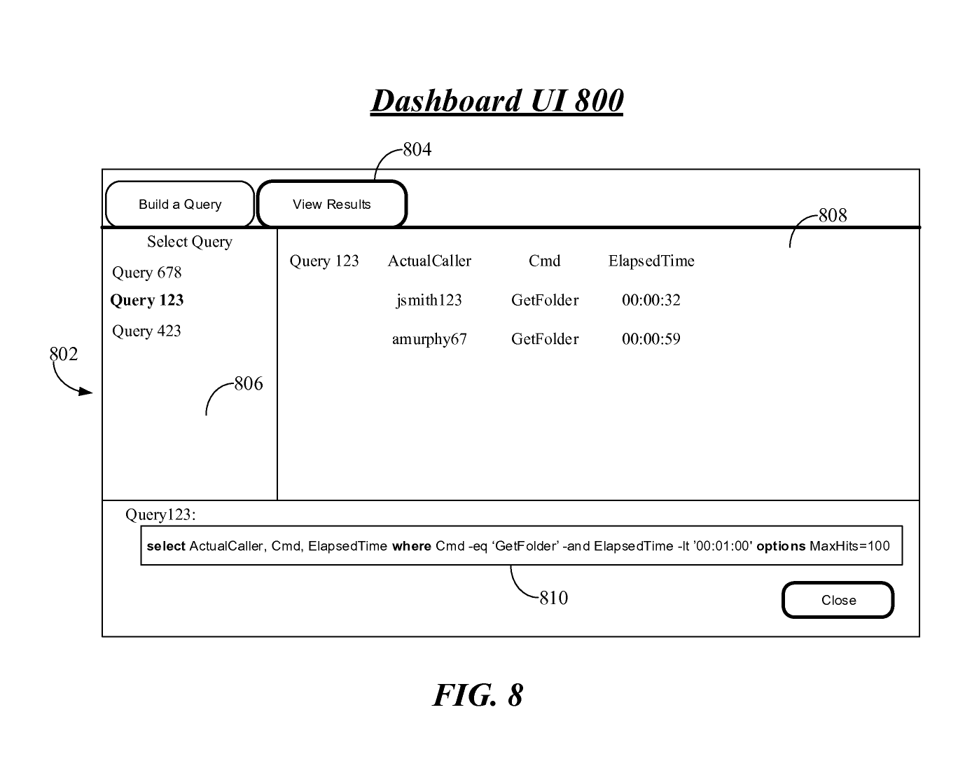

FIGS. 7 and 8 illustrate embodiments of a user interface (UI) that may be available on client device 110 to construct queries and view any results. The UI may be a stand-alone application executing on the processor circuit 102. The UI may be presented in a web browser application, served, for example, from services center 150. Alternatively, the UI may be a component of an application, for example, an administrator toolbox application (not shown) that allows an operator 108 to affect the functioning of services center 150 from client device 110. The embodiments are not limited to these examples.

FIG. 7 illustrates an embodiment of a dashboard user interface (UI) 700. Dashboard UI 700 may be displayed on client device 110 and may be usable by operator 108 to construct a query for diagnosing a live service. Dash board UI 700 may include a query building panel 702, which may be accessed, for example, via a tab 704.

Query building panel 702 may include various UI elements that allow the operator 108 to construct the conditional handler and query. For example, query building panel 702 may include a selection mechanism 706 to specify which “box”, e.g. a specific server device 152 to diagnose. The selection mechanism may include any UI means for selecting, such as, but not limited to, a pull-down menu populated with available server device names, a text field for entry of a server device name from an input device, a list of buttons or checkboxes for each available server device and so forth.

The query building panel 702 may include a selection mechanism 708 to specify which request handler component 230 to diagnose. Selection mechanism 708 may further allow the operator to select a specific process to diagnose. The available selections provided by selection mechanism 708 may be populated once the box is selected, and may be populated according to the registered processes exposed by the RPC server component 220 on the selected box.

The query building panel 702 may include a selection mechanism 710 to specify one or more properties to fetch when a condition is true. The available selections provided by selection mechanism 710 may be populated once the process is selected, and may be populated according to the process data 240 exposed by the RPC server component 220 on the selected box.

The query building panel 702 may include a selection mechanism 712 to specify one or more conditions to evaluate. The available selections provided by selection mechanism 710 may be populated once the process is selected, and may be populated according to the process data 240 exposed by the RPC server component 220 on the selected box. Since a condition usually involves checking the value of a property, a condition selection mechanism 712 may include a first selection of a property, and a second selection of a value to watch for. Additionally, a complex condition may be constructed by combining a plurality of property-value pairings. Accordingly, a selection for various Boolean operators, e.g. OR, AND, NOT and so forth, may be provided to construct a complex condition.

The query building panel 702 may include a selection mechanism 714 to specify one or more options to modify condition evaluation. The available selections provided by selection mechanism 710 may be independent of the properties selected and/or may include options that are specific to a property.

Query building panel 702 may include a field 716 that displays the query as it is built. In an embodiments, the field 716 may allow the operator to edit the query directly within the field. Query building panel 702 may include a submit button 718 that when selected by a control directive from operator 108, submits the conditional handler with query to the selected RPC server component 220.

In some embodiments, a query and/or conditional handler may be constructed on a command line interface as an alternative to a dashboard UI. In a command line interface, the query as it appears in field 716 may be entered from any interface capable of accepting operator input and generating a text string.

FIG. 8 illustrates a block diagram of a dashboard user interface (UI) 800. The dashboard UI 800 may be a second view of dashboard UI 700. Dashboard UI 800 may include a results pane 802, which may be accessed, for example, when a tab 804 is selected.

Results pane 802 may comprise a query selection sub-pane 806 and a query result sub-pane 808. Query selection sub-pane 806 may show a list or other grouping of the queries that are currently registered by the client device 110. The list may allow the operator to select one of the queries, e.g. “query 123” as illustrated.

When a query in query selection sub-pane 806 is selected, query result sub-pane 808 may display any data in a log file generated in response to the selected query. Query 123 specifies that three properties are to be returned: the actual caller, the command, and the elapsed time. Query result sub-pane 808 may display a grid, chart, table, or other presentation that shows each fetched property and its value when collected. Query result sub-pane 808 may open the log file and format the contents for display, or may open the log file and present the log file without additional formatting. The embodiments are not limited to this example.

In some embodiments, the log file may be retrieved using a command line interface as an alternative to a dashboard UI.

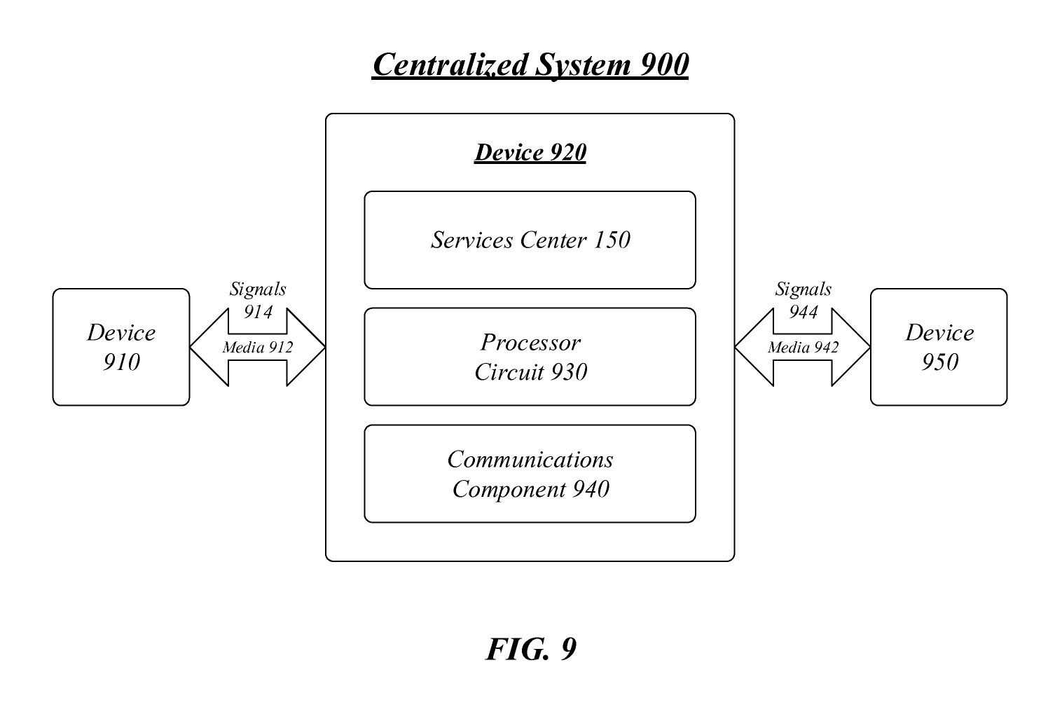

FIG. 9 illustrates a block diagram of a centralized system 900. The centralized system 900 may implement some or all of the structure and/or operations for the system 100 in a single computing entity, such as entirely within a single device 920.

The device 920 may comprise some or all of the components of services center 150 and may also include a communications component 940.

The device 920 may execute communications operations or logic for the system 100 using communications component 940. The communications component 940 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 940 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 912, 942 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 920 may communicate with other devices 910, 950 over a communications media 912, 942, respectively, using communications signals 914, 944, respectively, via the communications component 940. The devices 910, 950 may be internal or external to the device 920 as desired for a given implementation. Devices 910, 950 may include, for example, client devices 110 and devices that assist in the provision of services.

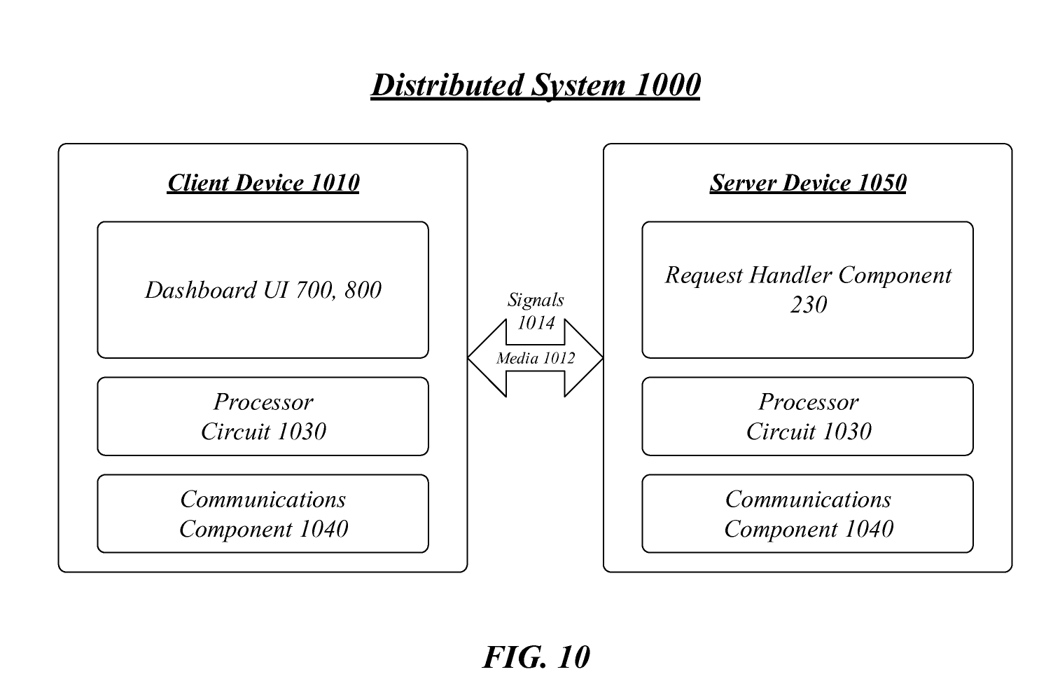

FIG. 10 illustrates a block diagram of a distributed system 1000. The distributed system 1000 may distribute portions of the structure and/or operations for the system 100 across multiple computing entities. Examples of distributed system 1000 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1000 may comprise a client device 1010 and a server device 1050. In general, the client device 1010 and the server device 1050 may be the same or similar to the client device 110 and client device 920 as described with reference to FIGS. 1 and 9. For instance, the client system 1010 and the server system 1050 may each comprise a processing component 1030 and a communications component 1040 which are the same or similar to the processor circuit 102 and the communications component 940, respectively, as described with reference to FIGS. 1 and 9. In another example, the devices 1010, 1050 may communicate over a communications media 1012 using communications signals 1014 via the communications components 1040.

The client device 1010 may comprise or employ one or more client programs that operate to perform various methodologies in accordance with the described embodiments. In one embodiment, for example, the client device 1010 may implement dashboard UI 700, 800.

The server device 1050 may comprise or employ one or more server programs that operate to perform various methodologies in accordance with the described embodiments. In one embodiment, for example, the server device 1050 may implement at least request handler component 230. The client device 1010 may be using a dashboard UI 700, 800 and may submit queries and request results from the server device 1050.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

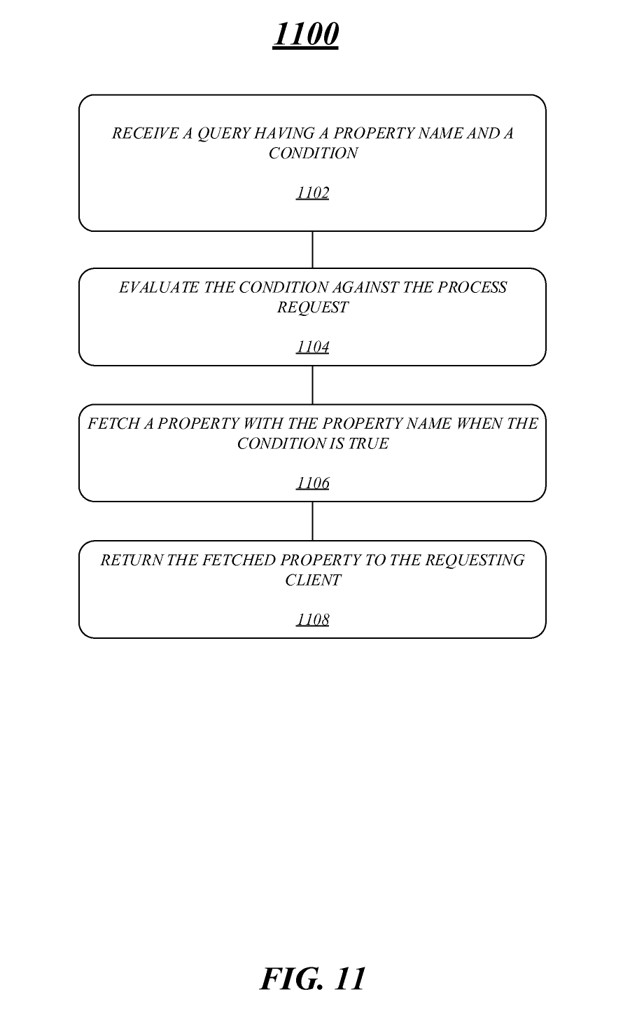

FIG. 11 illustrates one embodiment of a logic flow 1100. The logic flow 1100 may be representative of some or all of the operations executed by one or more embodiments described herein. In particular, the logic flow 1100 may represent the operations executed by a process object, e.g. process object 232, 310 and/or a request handler component, e.g. request handler component 230 and its processes.

In the illustrated embodiment shown in FIG. 11, the logic flow 1100 may receive a query having a property to fetch and a condition, at block 1102. For example, process object 232 may receive a query from a conditional handler submitted by a client device and passed to the process object 232 from the process to be monitored. When received, the process object may further parse the query into one or more conditionals; and may store the conditionals in a conditional cache.

The logic flow 1100 may evaluate the condition against the executing process request at block 1104. For example, at any point during or after a process request is executed or serviced by the process that owns process object 232, the process may prompt the process object to evaluate any conditionals in the conditional cache against the current state of the process. For example, if a conditional specifies a property name and a value for that property name, process object 232 may request the property and value from the process, and compare the value in the conditional with the value received from the process.

The logic flow 1100 may fetch the property when the condition is true at block 1106. For example, when a value in a conditional matches the value of a monitored property, the process object 232 may request the property specified in the query from the process. The process object may use the pointer 360 to access the properties of the process or may request via a function or procedure call to the process.

The logic flow 1100 may return the fetched property to a client that sent the query at block 1108. For example, the process object may return the fetched property to the RPC server component 220 to pass back to the client, or may write the fetched property to a log file 250. In an embodiment, process object 232 may inform the RPC server component 220 that a log file was created and/or written to.

As described herein, embodiments may provide a non-invasive, event-based data collection technique that does not require, for example, that a debugger be attached to a process or that all process be captured. The ability to define a query dynamically using whatever properties a process exposes provides greater diagnostic flexibility that does not require that a process or the service be re-compiled and re-deployed. In some embodiments, existing processes may have to be recompiled in order to include a process object within the process. The embodiments also effectively allow a process to be treated as though the process were a dataset or database from which information can be requested.

In addition to providing diagnostic capability, the embodiments may be extended to provide, for example, error correction or mitigation. For example, once the conditions surrounding a problem are diagnosed then those conditions can be watched for. When the condition is met, it may be possible to deny the service, pass the request to another server, return a specific error code, break an error loop, or execute some other set of instructions that prevent or minimize the error effects. Once the cause of the error is repaired, the conditionals can be removed or expired.

FIG. 12 illustrates an embodiment of an exemplary computing architecture 1200 suitable for implementing various embodiments as previously described. In one embodiment, the computing architecture 1200 may comprise or be implemented as part of an electronic device. Examples of an electronic device may include those described with reference to FIGS. 1 and 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1200. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1200 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1200.

As shown in FIG. 12, the computing architecture 1200 comprises a processing unit 1204, a system memory 1206 and a system bus 1208. The processing unit 1204 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1204.

The system bus 1208 provides an interface for system components including, but not limited to, the system memory 1206 to the processing unit 1204. The system bus 1208 can be any of several types of bus structure that may further interconnect to a memory bus (with or without a memory controller), a peripheral bus, and a local bus using any of a variety of commercially available bus architectures. Interface adapters may connect to the system bus 1208 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1200 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1206 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computer 1202 may include various types of computer-readable storage media in the form of one or more lower speed memory units, including an internal (or external) hard disk drive (HDD) 1214, a magnetic floppy disk drive (FDD) 1216 to read from or write to a removable magnetic disk 1218, and an optical disk drive 1210 to read from or write to a removable optical disk 1222 (e.g., a CD-ROM or DVD). The HDD 1214, FDD 1216 and optical disk drive 1210 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1294 interface technologies.

The drives and associated computer-readable storage media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236. In one embodiment, the one or more application programs 1232, other program modules 1234, and program data 1236 can include, for example, the various applications and/or components of the system 100.

A user can enter commands and information into the computer 1202 through one or more wire/wireless input devices, for example, a keyboard 1238 and a pointing device, such as a mouse 1240. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1204 through an input device interface 1242 that is coupled to the system bus 1208, but can be connected by other interfaces such as a parallel port, IEEE 1294 serial port, a game port, a USB port, an IR interface, and so forth.

A monitor 1244 or other type of display device is also connected to the system bus 1208 via an interface, such as a video adaptor 1246. The monitor 1244 may be internal or external to the computer 1202. In addition to the monitor 1244, a computer typically includes other peripheral output devices, such as speakers, printers, and so forth.

The computer 1202 may operate in a networked environment using logical connections via wire and/or wireless communications to one or more remote computers, such as a remote computer 1248. The remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

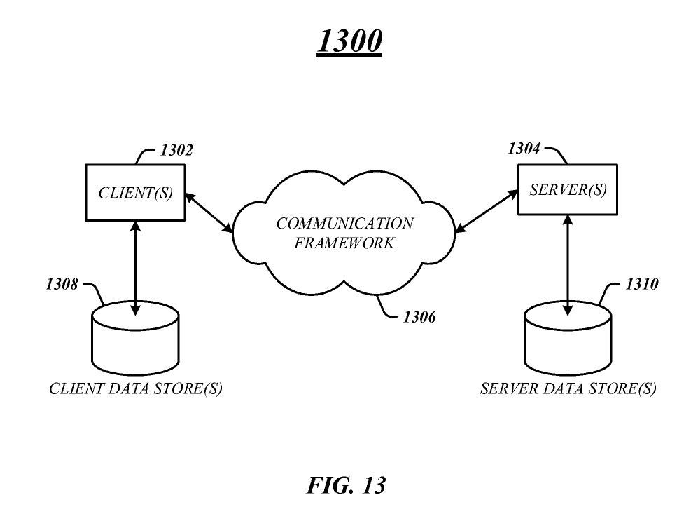

FIG. 13 illustrates a block diagram of an exemplary communications architecture 1300 suitable for implementing various embodiments as previously described. The communications architecture 1300 includes various common communications elements, such as a transmitter, receiver, transceiver, radio, network interface, baseband processor, antenna, amplifiers, filters, power supplies, and so forth. The embodiments, however, are not limited to implementation by the communications architecture 1300.

As shown in FIG. 13, the communications architecture 1300 comprises includes one or more clients 1302 and servers 1304. The clients 1302 may implement the client device 910. The servers 1304 may implement the server device 950. The clients 1302 and the servers 1304 are operatively connected to one or more respective client data stores 1308 and server data stores 1310 that can be employed to store information local to the respective clients 1302 and servers 1304, such as cookies and/or associated contextual information.

The clients 1302 and the servers 1304 may communicate information between each other using a communication framework 1306. The communications framework 1306 may implement any well-known communications techniques and protocols. The communications framework 1306 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1306 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1302 and the servers 1304. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor circuit; and
a request handler component for execution on the processor circuit to service a process request, wherein process data is generated, the request handler component comprising:
a process object to receive a query comprising a property name and a condition, the process object further comprising:
a condition evaluator to evaluate the condition against the process request; and
a data requestor to fetch a property associated with the property name from the process data when the condition is true, and write the property to a log file.

2. The apparatus of claim 1, the process to register with a remote procedure call (RPC) server component when the process starts up, the registering including a set of process data that the process is exposing.

3. The apparatus of claim 1, the process object comprising a query parser to parse the query into one or more conditionals and store the one or more conditionals in a conditional cache for evaluation.

4. The apparatus of claim 1, the process object including a pointer to the process data, wherein the data requestor uses the pointer to the process data to fetch the property.

5. The apparatus of claim 1, wherein the process data comprises at least one of diagnostic data and metadata.

6. The apparatus of claim 1, wherein the process prompts the process object to evaluate the condition.

7. The apparatus of claim 1, the query further comprising metadata to modify the condition.

8. The apparatus of claim 1, the process object to register the query with a remote procedure call (RPC) server component and provide an identifier for the query.

9. A computer-implemented method, comprising:
receiving a query with a property name and a condition at a process;
evaluating the condition against an executing process request;
fetching a property with the property name when the condition is true; and
returning the fetched property to a client that sent the query.

10. The computer-implemented method of claim 9, comprising:
registering the request handler component with a remote procedure call (RPC) server component when the process starts; and
receiving the process request from the RPC server component.

11. The computer-implemented method of claim 9, comprising:
writing the fetched property to a log file.

12. The computer-implemented method of claim 11, comprising:
receiving a request to view the log file from the client; and
providing to the client at least one of: the log file and a link to the log file.

13. The computer-implemented method of claim 9, comprising:
registering an identifier for the query at a remote procedure call (RPC) server component; and
returning the identifier to the client that sent the query.

14. The computer-implemented method of claim 9, comprising:
parsing the query into one or more conditionals; and
storing the conditionals in a conditional cache.

15. At least one computer-readable storage memory unit comprising instructions that, when executed, cause a system to:
receive a query comprising a property to fetch and a condition;
evaluate the condition against a process request;
fetch the property from process data when the condition is true; and
return the fetched property to a client that sent the query.

16. The computer-readable storage medium of claim 15, comprising instructions that when executed cause the system to register the query with a remote procedure call (RPC) server component and provide an identifier for the query.

17. The computer-readable storage medium of claim 15, comprising instructions that when executed cause the system to:
parse the query into one or more conditionals; and
store the one or more conditionals in a conditional cache for evaluation against the process request.

18. The computer-readable storage medium of claim 17, comprising instructions that when executed cause the system to write the fetched property to a log file.

19. The computer-readable storage medium of claim 15, comprising instructions that when executed cause the system to evaluate the condition against the process request while the process request is executing or after the process request is executed.

20. The computer-readable storage medium of claim 15, comprising instructions that when executed cause the system to receive a prompt from the process request to evaluate the condition.
